(19) United States
(12) Patent Application Publication
(10) Pub. No.: US 2004/0099717 A1
(43) Pub. Date: May 27, 2004

(54) Colorful-indexing portfolio

(76) Inventor: Fei-Chen Lee, Yung He City (TW)

Correspondence Address: Niro, Scavone, Haller & Niro, Suite 4600, 191 West Madison Street, Chicago, IL, 60602-4515, US

(21) Appl. No.: 10/304,228

(22) Filed: Nov. 26, 2002

(51) Int. Cl. B42F 21/00

(52) U.S. Cl. 229/67.3; 40/359; 229/67.4

(57) ABSTRACT

The purpose of this invention is to provide a portfolio having plural colorful dividers for indexing. The portfolio includes a case body, plural dividers having respective free edges and disposed in the case body to form plural containing partitions, and plural tabs extending from the respective free edges of the dividers, wherein the plural tabs have respective colors to form a specific color combination for indexing the plural partitions respectively.

### FIELD OF THE INVENTION

The present invention is related to a portfolio and more particularly, to a colorful-indexing portfolio.

### BACKGROUND OF THE INVENTION

One of the most difficult on-going tasks faced by a businessperson is information management. Among the information a businessperson must manage and organize is information relating to appointments, expenses, addresses and telephone numbers, business cards, and general information relating to clients and customers.

A wide variety of devices exist that help the businessperson organize and manage this material. For example, someone provides a wide variety of currently available information management portfolio by means of inserting plural index divider sheets with insertable index tabs have long been in use. Such portfolio with index tabs are well known to a lot of school children and businessmen, who use them in dividing notebooks according to school subjects, reports according to chapters, and presentations according to sections, as well as any other use where a collection of materials must be subdivided into sections that can be easily accessed.

Please refer to FIG. 1. FIG. 1 illustrates a portfolio with plural tabular index divider sheets of the prior art. The portfolio includes a case body 11, plural divider 12 secured to the case body 11, and plural tabular index tabs 13 extending from a free edge of the case body 11 for indexing. According to the prior art, when plural tabular index tabs 13 are put together in the case body 11, we can't directly distinguish those tabular index tabs 13 because all tabular index tabs 13 are in the same shape and color. FIG. 2 illustrates another portfolio according to the prior art. The portfolio includes a case body 21, plural divider 22 secured to the case body 21, and plural tabular index tabs 23 extending from one edge of the case body 21 for indexing. When the case body 21 is extended, we can't directly distinguish those tabular index tabs 13 either because all tabular index tabs 13 are in the same shape and color. If the user hopes to distinguish the index tabs directly, he always has to provide other indexing objects adhered on the index tabs.

Therefore, it is tried to rectify this drawback by the present applicant. The invention provides a portfolio having plural colorful dividers for indexing directly and easily.

### SUMMARY OF THE INVENTION

It is therefore a primary objective of the present invention to provide a portfolio having plural colorful dividers for indexing.

According to the present invention, the portfolio includes a case body, plural dividers having respective free edges and disposed in the case body to form plural containing partitions, and plural tabs extending from the respective free edges of the dividers, wherein the plural tabs have respective colors to form a specific color combination for indexing the plural partitions respectively.

Preferably, each divider has two opposite edges secured to the case body.

Certainly, the specific color combination can be to simulate a rainbow.

Preferably, the respective divider and the respective tab are in the same color.

Certainly, the respective divider and the respective tab can be of one unity.

Preferably, the plural dividers have different sizes

Preferably, the plural tabs are differently shaped.

Preferably, the plural tabs have different sizes.

Certainly, the case body can be an extendable container.

Certainly, the case body can be a translucent body.

Certainly, the case body can be a transparent body.

Preferably, the case body further includes an opening for showing the specific color combination.

Certainly, each tab can be an insertable index tab.

Preferably, the insertable index tab is a folded holder for holding an indexing card.

According to the present invention, the portfolio includes a case body, and plural dividers disposed in the case body to form plural partitions, wherein the plural dividers have different sizes and different colors to form a specific color combination for indexing the plural partitions respectively.

Preferably, each divider has two opposite edges secured to the case body.

Certainly, the specific color combination can be to simulate a rainbow.

Preferably, the plural dividers have different sizes.

Preferably, the plural dividers have the same shape.

Preferably, the case body is an extendable container.

Preferably, the case body is a translucent body.

Preferably, the case body is a transparent body

Preferably, the case body further includes an opening for showing the specific color combination.

The foregoing and other features and advantages of the present invention will be more clearly understood through the following descriptions with reference to the drawings, wherein:

### BRIEF DESCRIPTION OF THE DRAWING

FIG. 1 illustrates a portfolio having plural indexing tabs according to the prior art;

FIG. 2 illustrates another portfolio having plural indexing tabs according to the prior art;

FIG. 3 illustrates a portfolio having plural colorful-indexing tabs according to the present invention; and

FIG. 4 illustrates another embodiment of a colorful-indexing portfolio according to the present invention.

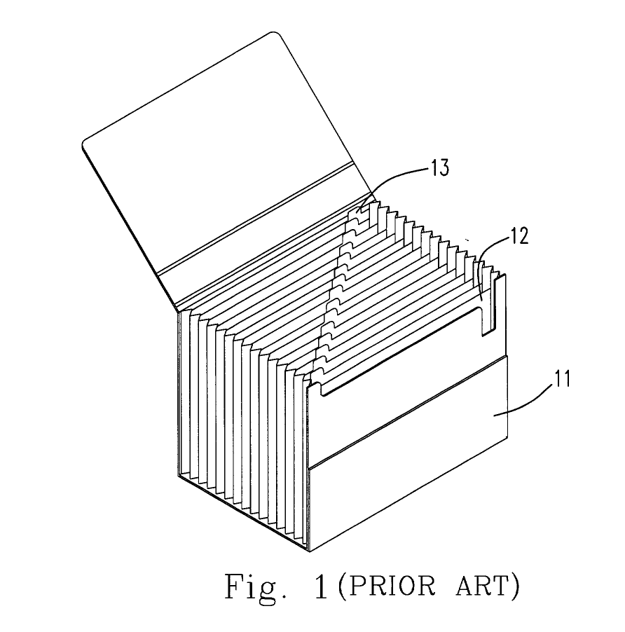

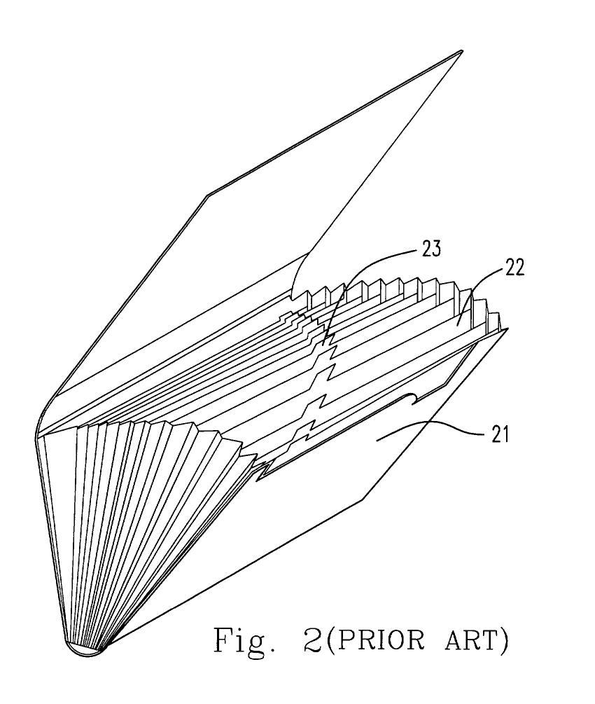

### DETAILED DESCRIPTION OF THE PREFERRED EMBODIMENTS

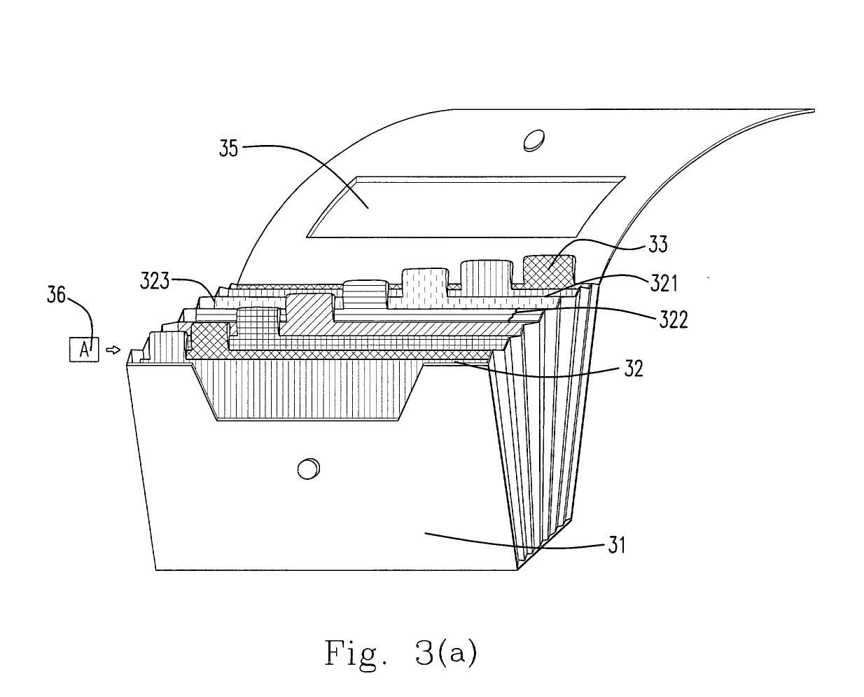

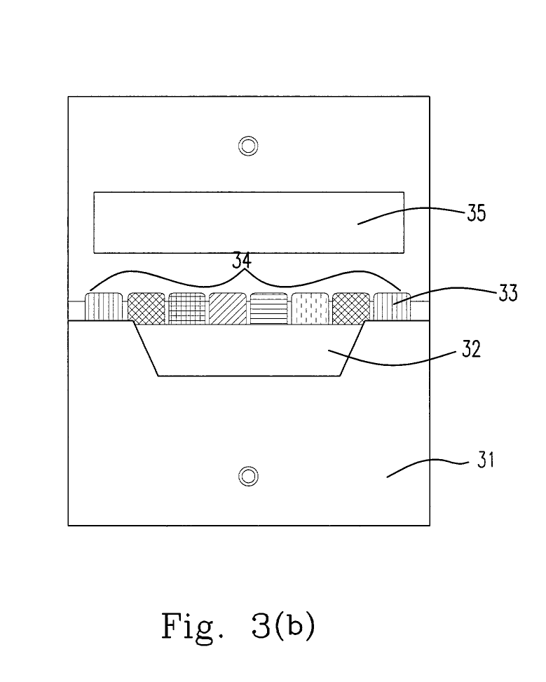

The purpose of this invention is to provide a portfolio having plural colorful dividers for indexing. Please refer to FIGS. 3(a) and 3(b). They illustrate a portfolio includes a case body 31, plural dividers 32 having respective free edges 321 and disposed in the case body 31 to form plural containing partitions 322, and plural tabs 33 extending from the respective free edges 321 of the dividers 32, wherein the plural tabs 33 have respective colors to form a specific color combination 34 for indexing the plural partitions 322 respectively. Meanwhile each divider 32 has two opposite edges 323 secured to the case body 31. The specific color combination 34 can be to simulate a rainbow.

Preferably, the respective divider 32 and the respective tab 33 can be in the same color, shown in FIG. 3(a), wherein the respective divider 32 and the respective tab 33 can be of one unity. Certainly, the respective divider 32 and the respective tab 33 can be in the different colors, shown in FIG. 3(b), wherein the plural divider 32 are in one color and the plural tabs 33 have respective colors. For showing the specific color combination 34, the case body can be a translucent body or a transparent body. Preferably, the case body 31 is an extendable container. The case body 34 can be an opaque body. Certainly, the case body 34 can also include an opening 35 for showing the specific color combination 34. Additionally, each tab 33 in FIGS. 3(a) and 3(b) can be an insertable index tab, which is a folded holder for holding an indexing card 36.

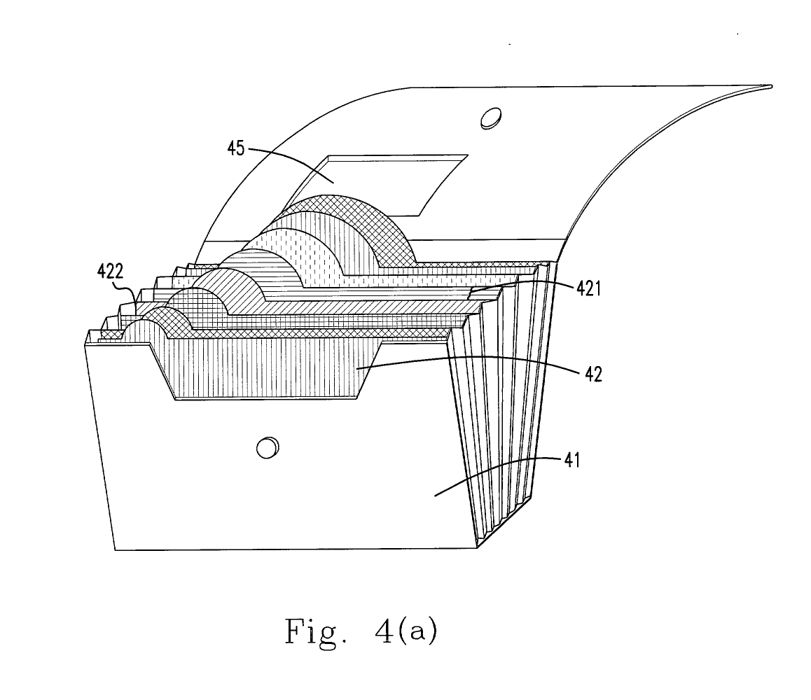

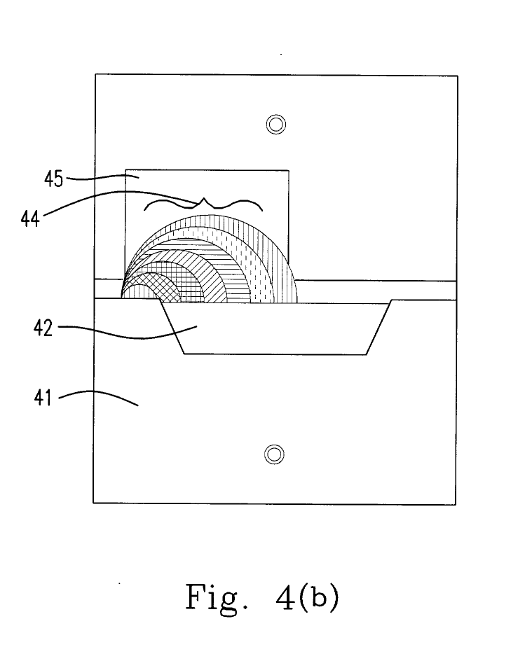

According to the present invention, FIG. 4 illustrates another portfolio, which includes a case body 41, and plural dividers 42 disposed in the case body 41 to form plural partitions 421, wherein the plural dividers 42 have different sizes and different colors to form a specific color combination 44 for indexing the plural partitions 421 respectively. Similarly, each divider 42 has two opposite edges 422 secured to the case body 41. The plural dividers 42 have different sizes in the similar shapes. In FIG. 4, the sizes of the plural divider 42 are increasing for simulating a rainbow. For showing the specific color combination 44, the case body can be a translucent body or a transparent body. Preferably, the case body 41 is an extendable container. The case body 44 can be an opaque body. Certainly, the case body 44 can also include an opening 45 for showing the specific color combination 44. Additionally, the specific color combination 44 may protrude from the opening 45 for showing or fastening.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims, which are to be accorded with the broadest interpretation so as to encompass all such modifications and similar structures.

### Attachment

### Attorneys of Niro, Scavone, Haller & Niro

Raymond P. Niro Reg. No. 24,131

Thomas g. Scavone Reg. No. 26,801

Timothy J. Haller Reg. No. 26,692

Joseph N. Hosteny Reg. No. 28,020

Robert A. Vitale, Jr. Reg. No. 32,319

John C. Janka Reg. No. 32,996

Michael P. Mazza Reg. No. 34,092

Richard B. Megley, Sr. Reg. No. 21,102

Dean D. Niro Reg. No. 36,881

Keith A. Vogt Reg. No. 37,252

Arthur A. Gasey Reg. No. 35,150

Robert P. Greenspoon Reg. No. 40,004

Christopher J. Lee Reg. No. 41,934

Richard B. Megley, Jr. Reg. No. 41,992

Vasilios D. Dossas Reg. No. 30,745

What is claimed is:

1. A portfolio comprising:
a case body;
plural dividers having respective free edges and disposed in said case body to form plural containing partitions; and
plural tabs extending from said respective free edges of said dividers, wherein said plural tabs have respective colors to form a specific color combination for indexing said plural partitions respectively.

2. The portfolio according to claim 1, wherein each said divider has two opposite edges secured to said case body.

3. The portfolio according to claim 1, wherein said specific color combination is to simulate a rainbow.

4. The portfolio according to claim 1, wherein said respective divider and said respective tab are in the same color.

5. The portfolio according to claim 1, wherein said respective divider and said respective tab are of one unity.

6. The portfolio according to claim 1, wherein said plural dividers have different sizes.

7. The portfolio according to claim 1, wherein said plural tabs are differently shaped.

8. The portfolio according to claim 1, wherein said plural tabs have different sizes.

9. The portfolio according to claim 1, wherein said case body is an extendable container.

10. The portfolio according to claim 1, wherein said case body is a translucent body.

11. The portfolio according to claim 1, wherein said case body is an opaque body.

12. The portfolio according to claim 1, wherein said case body is a transparent body.

13. The portfolio according to claim 1, wherein said case body further comprises an opening for showing said specific color combination.

14. The portfolio according to claim 1, wherein each said tab is an insertable index tab.

15. The portfolio according to claim 14, wherein said insertable index tab is a folded holder for holding an indexing card.

16. A portfolio comprising:
a case body; and
plural dividers disposed in said case body to form plural partitions, wherein said plural dividers have different sizes and different colors to form a specific color combination for indexing said plural partitions respectively.

17. The portfolio according to claim 16, wherein each said divider has two opposite edges secured to said case body.

18. The portfolio according to claim 16, wherein said specific color combination is to simulate a rainbow.

19. The portfolio according to claim 16, wherein said plural dividers have different sizes.

20. The portfolio according to claim 16, wherein said plural dividers have the same shape.

21. The portfolio according to claim 16, wherein said case body is an extendable container.

22. The portfolio according to claim 16, wherein said case body is a translucent body.

23. The portfolio according to claim 16, wherein said case body is a transparent body.

24. The portfolio according to claim 16, wherein said case body is an opaque body.

25. The portfolio according to claim 24, wherein said case body further comprises an opening for showing said specific color combination.
